(19) United States
(12) Patent Application Publication
(10) Pub. No.: US 2014/0028021 A1
(43) Pub. Date: Jan. 30, 2014

(54) ASSEMBLY HAVING A FLANGE

(71) Applicant: Wolfgang Freund, Gelsenkirchen (DE)

(72) Inventor: Wolfgang Freund, Gelsenkirchen (DE)

(21) Appl. No.: 14/110,739

(22) PCT Filed: Apr. 13, 2012
(86) PCT No.: PCT/EP2012/056778

§ 371 Date: Oct. 9, 2013

(30) Foreign Application Priority Data
Apr. 14, 2011 (DE) 10 2011 007 388.4

(51) Int. Cl. F16L 23/18

(52) U.S. Cl. CPC F16L 23/18
USPC 285/364

(57) ABSTRACT

An assembly with flanges is provided. The flanges are used for welding onto a pipe end of a pipe for a pressure-bearing flange connection of two pipe ends, wherein the flange extends in a circumferential direction about a central axis of the pipe and has a first end face in the axial direction of the pipe end, wherein the first end face has a sealing groove extending in the circumferential direction, which sealing groove divides the end face into a radially inner inside surface and a radially outer outside surface. In order to avoid rework, the inside surface is axially recessed by a recess on average relative to the outside surface. An adaptation ring or an assembly having a flange or adaptation ring is also provided.

### CROSS REFERENCE TO RELATED APPLICATIONS

This application is the US National Stage of International Application No. PCT/EP2012/056778 filed Apr. 13, 2012 and claims benefit thereof, the entire content of which is hereby incorporated herein by reference. The International Application claims priority to the German application No. 10 2011 007388.4 DE filed Apr. 14, 2011, the entire contents of which is hereby incorporated herein by reference.

### FIELD OF INVENTION

The invention relates to an assembly with at least one flange for welding onto a pipe end of a pipe for a pressure-bearing flange connection of two pipe ends, and with at least one seal and with a mating flange, wherein the flange and the mating flange are clamped against each other by means of fastening elements, squashing the seal which is arranged in the seal groove, wherein the flange extends around a central axis of the pipe along a circumferential direction, and a first end face points in the axial direction of the pipe end, wherein the first end face has a circumferentially extending seal groove, which seal groove splits the end face into an inner surface, located radially on the inside, which in the main extends radially and is flat, and an outer surface, located radially on the outside, which in the main extends radially and is flat, wherein the inner surface is axially set back on average by an offset in relation to the outer surface.

### BACKGROUND OF INVENTION

Furthermore, the invention also relates to a similar assembly with an adapter ring for a pressure-bearing flange connection of two pipe ends for arranging between two flanges.

Flanges of the type referred to in the introduction are regularly used on pressure-bearing pipe connections. In this case, it preferably concerns weld-on flanges, weld neck flanges or loose flanges with a weld-on collar, especially in accordance with EN 1092-1, DIN 2632 to DIN 2638, ASME B16.5 or ASME B16.47.

Flange connections are known from U.S. Pat. No. 5,904,382 A, in which flange connections the screws are not stressed in the axial direction of the pipe since the forces in the axial direction of the pipe are absorbed by means of encompassing clamps which exert pressure upon the seal over defined inclined planes. The gap between the flanges which is provided according to plan serves only for locating the seal in the main force flux in a guaranteed manner A compensation of flange-plate inclinations is neither planned nor possible with this construction. The flange plate rotations need to be almost 0 so that pressure can be transmitted onto the seal by the clamps via the inclined planes.

A flange connection is known from DE 43 40051 A1, in which a flange-plate inclination, on account of the screwing forces, attributable to the shape of the flange sealing surface, which occur during assembly, leads to no lowering of the force on the seal. Inclinations of the flange plates as a result of weld contraction stresses extend in exactly the opposite direction and cannot be compensated by this construction.

(D1) GB 577,700 A

An application was filed in this case for a flange connection in which the flange plates lay one upon the other up to the outside diameter of the flange plates, that is to say a rotation of the flange is not permissible according to plan. The gap provided on the inside diameter of the flanges serves only for the internal pressure being able to act on the inside diameter of the seal and therefore forces the seal radially outward, which means additional seal tightness. A compensation of flange-plate inclinations is neither planned nor possible with this construction.

(D2) U.S. Pat. No. 5,904,382 A

An application was filed in this case for flange connections in which the screws are not stressed in the axial direction of the pipe since the forces in the axial direction of the pipe are absorbed by encompassing clamps which exert pressure onto the seal via defined inclined planes. The gap between the flanges which is provided according to plan serves only for locating the seal in the principle force flux in a guaranteed manner. A compensation of flange-plate inclinations is neither planned nor possible with this construction. The flange-plate rotations need to tend towards zero so that pressure can be transmitted onto the seal by the clamps via the inclined planes.

DE 43 40051 A1 features a flange connection in which a flange-plate inclination, on account of the screwing forces, attributable to the shape of the flange sealing surface, which occur during assembly, leads to no lowering of the force on the seal. Inclinations of the flange plates as a result of weld contraction stresses regularly extend in the opposite direction and cannot be compensated by this construction.

Described in DE 295 04 402 U1 is the known geometry of the Jungtec serrated seal with soft material insert. The lateral serrations in this case fix the soft material insert which is to provide the primary sealing. A compensation of flange-blade inclinations is possible only to a limited extent with this construction. In the case of larger flange-blade inclinations, the soft material seal is unloaded and the metallic serrated comb is loaded.

On account of the welding of flange which is to be used to the connecting pipe, inclinations, convexities and corrugations on the flange sealing surface regularly occur as a result of weld contraction stresses. On account of the high requirements for evenness of flange seals with O-rings in annular grooves, cost-intensive remachining operations of the flange sealing surface are necessary.

### SUMMARY OF INVENTION

The invention is based on the object of preventing this additional cost of remachining

Proposed for achieving the object according to the invention are flanges, adapter rings or arrangements of the type referred to in the introduction which have the additional features in the claims.

The invention is especially based on the knowledge that the evenness deviation on flange sealing surfaces almost always has a position inclination on the outside diameter so that the flange sealing surface describes a convex concavity. This inclination leads to the O-ring seal, with its projection from the seal groove beyond the sealing surfaces in some cases, no longer being in the position to compensate the tolerance-related waviness of the flange sealing surface over the circumference. The systematic inclination, especially as a result of the welding distortion, already consumes a large part of the available deformation path of the seal for its compensation. This inclination is a frequent reason for the necessity of a remachining of the flange face, which is particularly costly at site after the welding process. The design according to the invention of the flange is based on a corresponding inclination of the sealing surface of the mating flange and is geometrically prepared in a way that this inclination no longer decimated the squashing capability of the O-ring seal in its arrangement in the seal groove and the complete deformation capability of the O-ring seal is correspondingly made available for compensation of tolerance-related evenness defects of the oppositely-disposed flange sealing surface. The overriding idea of the invention lies in the transfer of the actually unplanned—but according to the invention recognized as being systematic—deviation of sealing surfaces of mating flanges into a planned consideration of this deviation by means of the geometry of the flange according to the invention.

In this case, axially on average with regard to a surface means that this surface has an area-averaged axial position and consequently, according to the invention, this area-weighted axial position of the inner surface in relation to the outer surface has an axial offset, or the radially inner surface is located axially further towards the pipe end in relation to the radial outer surface. In other words, this means that the flange or the adapter ring extends in the circumferential direction around a central axis and surface normals of sealing surfaces on the flange or adapter ring extend on average basically parallel or anti-parallel along the axial direction. The area-averaged axial position of the inner surface is set back in relation to the outer surface by an axial offset in terms of the surface normals of the inner surface or of the outer surface. The design according to the invention of an adapter ring for arranging between two flanges or mating flanges is based on the same idea as the flange according to the invention.

### BRIEF DESCRIPTION OF THE DRAWINGS

In the following text, the invention is described in more detail based on a specific exemplary embodiment with reference to drawings. In the drawings:

FIG. 1 shows a cross-sectional view of a flange according to the invention with a mating flange and

FIG. 2 shows a cross-sectional view of an adapter ring according to the invention with a mating flange.

### DETAILED DESCRIPTION OF INVENTION

In the following text, descriptions from the field of geometry of circular motion, such as axial, radial, circumference, diameter, circumferential direction, are in relation to a central axis which in the exemplary embodiments is provided with the designation AX, unless it be stated otherwise.

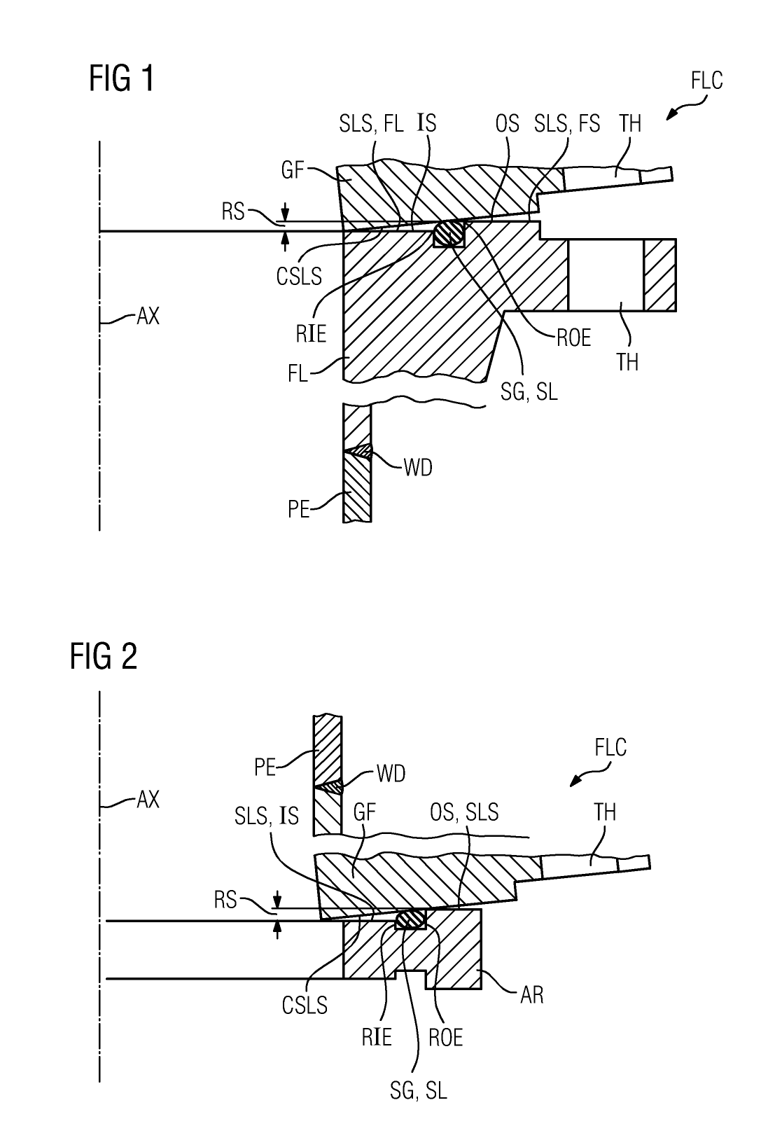

FIG. 1 shows a flange or pre-welded flange according to the invention based on DIN EN 1092-1 type 11. The flange FL extends in the main around an axis AX in a circumferential direction and is welded onto a pipe end PE in the region of a weld seam WD. Partially depicted in FIGS. 1, 2 is a flange in each case, referred to as a mating flange GF, which in many aspects is constructionally similar to the flange FL, which is expressed by the same designation. On an outside diameter, the flange FL is provided with through-holes TH at various positions of the circumference, which serve for fastening the flange FL on the mating flange GF by means of screws, which are not shown. The fastening is to be carried out in a way that a sealing surface SLS of the flange FL is pressed against a mating sealing surface CSLS of the mating flange GF. The sealing surface SLS is part of an axial end face FS of the flange FL, which axial end face FS is split by a circumferentially extending seal groove SG into a region located radially on the inside—an inner surface IS—and region located radially on the outside—an outer surface OS. The seal groove SG extends in a similar manner through the sealing surface SL which in this case is similarly split into the inner surface IS and the outer surface OS. The inner surface IS and the outer surface OS, or the sealing surface SLS, are designed in such a way that an arrangement for the mating flange GF and its mating sealing surface CSLS is created in a way that an at least partially radial surface overlap is provided between the inner surface IS and the mating sealing surface CSLS and also between the outer surface OS and the mating surface CSLS. The inner surface IS is axially set back in relation to the outer surface OS on the flange FL by an axial offset RS so that in the region of the seal groove SG a step is also created between the radially inner delimiting edge RIE and the radially outer delimiting edge ROE in the axial direction. The inner surface IS and the outer surface OS extend perpendicularly to the axis AX, or have no planned axial extent. Thus, the result is a perpendicular, purely radial extent of the inner surface IS and the outer surface OS in relation to the central axis AX. The mating sealing surface CSLS of the mating flange GF is inclined in relation to the radial direction as a result of a welding deformation in a way that the radially outer region of the mating sealing surface CSLS is axially set back in relation to the radially inner region of the mating sealing surface CSLS (opposite the direction of the central axis AX (anti-parallel) with regard to an inherent positive axial direction) and the ensuing sealing surface CSLS, as a result of this inclination, accordingly describes a convex conical shape in a spatial overall view. The sealing surface SLS of the flange FL is adapted to this inclination in a way that the described offset RS is about 1 mm. A seal SL, which in the installed state is located in the seal groove SG, is consequently squashed by the mating sealing surface CSLS in such a way that the overall deformation capability of the seal SL can be utilized to compensate the manufacturing-induced and tolerance-related unevenness or waviness of the mating sealing surface CSLS.

FIG. 2 shows an adapter ring AR according to the invention which in a comparable way extends around the axis AX in a circumferential direction. The adapter ring AR, like the sealing surface SLS of the flange FL, is formed in a comparable way on both end-face sealing surfaces SLS in such a way that the spatial convex conical inclination of the mating sealing surface CSLS of the mating flange GF is compensated. The adapter ring AR is axially surrounded, in a way not shown in more detail, by two mating-flange sealing surfaces CSLS (wherein only one mating sealing surface is shown), wherein the two mating flanges GF are clamped against each other by means of fastening elements, in a way not shown in more detail, in such a way that the adapter ring AR is clamped between the two mating flanges GF.

The flanges FL and adapter rings AR according to the invention are preferably used for pipe nominal widths of 200 mm-2000 mm, wherein the radial width of the sealing surface (that is to say the radial collar around the pipe) remains basically constant. The preferred size of the axial offset RS also remains more or less constant accordingly within a value range of 0.5 mm-1.5 mm, especially preferably 1 mm+/−0.1 mm The seal groove is preferably about 9 mm+/−3 mm wide in the radial direction.

1-3. (canceled)

4. An assembly, comprising:
a flange for welding onto a pipe end of a pipe for a pressure-bearing flange connection of two pipe ends;
a seal; and
a mating flange,
wherein the flange and the mating flange are clamped against each other by means of fastening elements, squashing the seal which is arranged in a seal groove,
wherein the flange extends around a central axis of the pipe along a circumferential direction, and a first end face points in an axial direction of the pipe end,
wherein the first end face includes the circumferentially extending seal groove, which seal groove splits the end face into an inner surface, located radially on the inside, which in the main extends radially and is flat, and an outer surface, located radially on the outside, which in the main extends radially and is flat, wherein the inner surface is axially set back on average by an offset in relation to the outer surface,
wherein the mating flange extends around the central axis of the pipe along the circumferential direction, and a first flat mating sealing surface points in the axial direction, and
wherein the mating sealing surface at least partially overlaps both the inner surface and the outer surface.

5. The assembly as claimed in claim 4, further comprising
two mating flanges for welding onto a pipe end in each case of a pipe for a pressure-bearing flange connection of two pipe ends, and
an adapter ring for arranging between the two mating flanges,
wherein the adapter ring extends around the central axis along a circumferential direction and on both axial end faces a first end face points in each case in the axial direction in the direction of the respective pipe end,
wherein at least one of the two first end faces has a circumferentially extending seal groove, which seal groove splits the end face into an inner surface, located radially on the inside, which in the main extends radially and is flat, and an outer surface, located radially on the outside, which in the main extends radially and is flat,
wherein the inner surface is axially set back on average by an offset in relation to the outer surface.
wherein the mating flange, which lies opposite the first end face, has a first flat mating sealing surface in the axial direction, and
wherein the mating sealing surface at least partially overlaps both the inner surface and the outer surface.

6. The assembly as claimed in claim 1, wherein the offset is between 0.5 mm and 1.5 mm

7. The assembly as claimed in claim 6, wherein the offset is 1 mm+/−0.1 mm.
